(19) United States
(12) Patent Application Publication
(10) Pub. No.: US 2016/0176374 A1
(43) Pub. Date: Jun. 23, 2016

(54) deformation device for a vehicle, and method for detecting a shortening of a deformation device for a vehicle

(71) Applicant: ROBERT BOSCH GMBH, Stuttgart (DE)

(72) Inventors: Heiko Freienstein, Weil Der Stadt (DE); Werner Nitschke, Asperg (DE)

(21) Appl. No.: 14/906,692

(22) PCT Filed: Jul. 21, 2014
(86) PCT No.: PCT/EP2014/065629

§ 371 Date: Jan. 21, 2016

(30) Foreign Application Priority Data
Jul. 22, 2013 (DE) 10 2013 214 302.8

(51) Int. Cl. B60R 21/0136; B62D 21/15

(52) U.S. Cl. CPC B60R 21/0136; B62D 21/15

(57) ABSTRACT

A deformation device for a vehicle includes: a deformation element which is designed for being shortened in the longitudinal direction by energy of an impact of the vehicle; at least two electrodes which are situated on the deformation element; and an interface for connecting the at least two electrodes to a resistance measuring unit in order to measure a resistance between the at least two electrodes.

### BACKGROUND OF THE INVENTION

1. Field of the Invention

The present invention relates to a deformation device for a vehicle, a method and a device for detecting a shortening of a deformation device for a vehicle, and a corresponding vehicle.

2. Description of the Related Art

Recent vehicles may include crash structures made of lightweight components. For example, a front end of a vehicle may be provided with a crash structure made of carbon fiber-reinforced plastic (CFRP). In contrast to conventional crash structures, which may be designed for being deformed by a collision of the vehicle, such lightweight components may be torn into small segments or pulverized due to the collision.

### BRIEF SUMMARY OF THE INVENTION

Against this background, with the present invention a deformation device for a vehicle, a method and a device for detecting a shortening of such a deformation device, and a corresponding vehicle are provided.

A deformation device for a vehicle is provided, the deformation device including the following features:

a deformation element which is designed for being shortened in the longitudinal direction by energy of an impact of the vehicle;
at least two electrodes which are situated on the deformation element; and
an interface for connecting the at least two electrodes to a resistance measuring unit for measuring a resistance between the at least two electrodes.

A deformation device may be understood to mean a structure of a vehicle which is designed for absorbing kinetic energy of an impact of the vehicle, and in the process being deformed or at least partially destroyed. For example, the deformation device may be situated in a front area and/or a rear area and/or a side area of the vehicle. A vehicle may be understood to mean a motor vehicle, in particular a motor vehicle for passenger transportation. The deformation device may include a deformation element which is designed for being shortened in the longitudinal direction, in particular torn or pulverized, due to the impact. The deformation element may be, for example, a cylindrical or cuboidal hollow body made of a fiber-plastic composite material. At least two electrodes may be situated on the deformation element. An electrode may generally be understood to mean an electron conductor. The at least two electrodes may be designed for conducting an electric current through a conductive material situated between the at least two electrodes. The deformation element may be formed from an electrically conductive material or may include an electrically conductive material. Additionally or alternatively, electrically conductive transverse lines may be situated on the deformation element. The conductive material between the at least two electrodes may thus be part of the deformation element. In this case, the conductive material of the deformation element may form an electrical transverse line between the at least two electrodes. Additionally or alternatively, additional conductive material may be combined with the deformation element in order to implement an electrical transverse line between the at least two electrodes. The deformation device may include an interface with a resistance measuring unit for measuring an electrical resistance between the at least two electrodes. Electrical lines or electrical connection contacts via which the electrodes may be connected to the resistance measuring unit in an electrically conductive manner may be understood as an interface. The resistance measuring unit may be a unit for ascertaining the resistance between the at least two electrodes. The resistance measuring unit may be designed for providing a measuring voltage necessary for measuring the resistance, or a measuring current necessary for measuring the resistance, at the interface of the deformation device.

The present approach is based on the finding that a recent deformation element of a vehicle may tear or crack instead of plastically deforming when absorbing impact energy. In contrast to a plastic deformation, electrical conductivity of the deformation element may be drastically influenced by this type of destruction or shortening of the deformation element. The present approach makes use of this property, in that the deformation element of a deformation device of the vehicle is equipped with at least two electrodes. The at least two electrodes may be electrically connected to one another via the deformation element itself, or via an additional electrical transverse line which may be situated on the deformation element transversely with respect to the longitudinal direction of the deformation element. A plurality of transverse lines situated in parallel may also be used. In addition, at least one transverse line having a flat design may be used, whose surface extends on the one hand between the at least two electrodes, and on the other hand in the longitudinal direction of the deformation element. A resistance between the at least two electrodes may be ascertained. The resistance may change due to the shortening of the deformation element, for example in the event of an impact of the vehicle, as the result of which the electrically conductive material of the deformation element or the at least one electrical transverse line is damaged. The resistance may be utilized, for example, for the early recognition of an impact speed and/or an impact angle of the vehicle.

The present approach may be integrated into an existing passenger protection device of the vehicle, using very simple, cost-effective means. The present approach may be advantageously implemented in a particularly weight-saving manner by using lightweight components.

According to one specific embodiment, the deformation device includes at least one electrically conductive transverse line. The at least one electrically conductive transverse line may be situated on the deformation element transversely with respect to the longitudinal direction of the deformation element and between the at least two electrodes. The electrically conductive transverse line may be integrated into the deformation element. The at least one electrically conductive transverse line may be formed by a structure of the deformation element, integrated into the deformation element as an additional element, or mounted on the deformation element. Such a transverse line is suitable when the material of the deformation element is not electrically conductive or is not sufficiently electrically conductive.

According to one specific embodiment of the present approach, the deformation device may include at least one further electrically conductive transverse line which is situated transversely with respect to the longitudinal direction of the deformation element and situated on the deformation element between the at least two electrodes, vertically offset with respect to the transverse line. The change in length of the deformation element may be determined particularly precisely by measuring the resistance between the at least two electrodes on multiple transverse lines situated vertically with respect to one another. For example, an approximately continuous length measurement may be achieved with the aid of a plurality of transverse lines placed closely together.

According to one specific embodiment of the present approach, the at least two electrodes may be designed as at least two electrically conductive longitudinal lines. The at least two longitudinal lines may be situated in the longitudinal direction of the deformation element. A longitudinal line may be understood to mean, for example, an electrical strip conductor which is integrated into the deformation element, or an electrically conductive material structure of the deformation element. The at least two longitudinal lines may be electrically connected to one another via material of the deformation element or via at least one separately implemented transverse line. The material of the deformation element or the at least one transverse line may extend flatly along a length of the longitudinal lines between the longitudinal lines. In addition, a plurality of transverse lines situated at a distance from one another may extend between the longitudinal lines.

According to one specific embodiment of the present approach, the at least two electrodes and/or the at least one transverse line may be woven into a structure of the deformation element. For example, the structure of the deformation element may be a fiber composite. Manufacturing costs may be saved in that the at least two electrodes and/or the transverse line are/is already woven in during manufacture of the fiber composite. In addition, the weight of the deformation element may thus be kept very low.

According to one specific embodiment of the present approach, the at least two electrodes and/or the at least one transverse line may be mounted on a surface of the deformation element. The at least two electrodes and/or the transverse line may be imprinted on the surface in the form of metallic strip conductors, for example. In addition, the weight of the deformation element may be kept very low at a low cost via this specific embodiment.

According to one specific embodiment of the present approach, the deformation device may include a third electrode which is situated on the deformation element. According to one specific embodiment, the third electrode may contact the at least one transverse line. Alternatively, the third electrode may be connected in an electrically conductive manner to at least one of the additional electrodes via the deformation element. In addition, the deformation device may include an additional interface for connecting the third electrode and one of the at least two electrodes to an additional resistance measuring unit for measuring an additional resistance between the third electrode and the one of the at least two electrodes.

An electrode system which includes three electrodes offers the advantage that an asymmetrical shortening of the deformation element, which may be caused, for example, by an oblique impact of the vehicle, may be ascertained. The resistance and the additional resistance may differ from one another. Using the resistance and the additional resistance, an accurate impact angle of the vehicle may be computed using cost-effective, simple means. In addition, such an electrode system ensures redundancy when measuring the resistances, as a result of which the operational reliability of the deformation device may be increased.

According to one specific embodiment of the present approach, the deformation device may include at least two additional electrodes, which are situated on the deformation element. According to one specific embodiment, the deformation device may include an additional electrically conductive transverse line which is situated transversely with respect to the longitudinal direction of the deformation element and between the at least two additional electrodes on the deformation element. Alternatively, the two additional electrodes may be connected to one another in an electrically conductive manner via the deformation element. Furthermore, the deformation device may include an additional interface for connecting the at least two additional electrodes to an additional resistance measuring unit for measuring an additional resistance between the at least two additional electrodes. By use of an electrode system which includes at least two additional electrodes, the operational reliability of the deformation device may be increased with a low outlay of costs and materials. An impact angle of the vehicle may thus be ascertained in a particularly reliable manner.

Moreover, the present approach provides a method for detecting a shortening of the mentioned deformation device. The method includes the following steps:

measuring the resistance between the at least two electrodes in order to obtain a resistance value; and
ascertaining a length of the deformation element, using the resistance value, in order to detect the shortening of the deformation device.

According to one specific embodiment of the present approach, the step of measuring may be carried out repeatedly in order to obtain a plurality of resistance values. In addition, a speed of the shortening of the deformation element may be ascertained in the step of ascertaining, using the plurality of resistance values. The resistance values may differ from one another due to a shortening of the deformation element. For example, the resistance values obtained prior to a shortening may represent a lower resistance between the at least two electrodes than the resistance values obtained after a shortening or during a shortening. The speed of the shortening of the deformation element may be efficiently and accurately ascertained, using a time interval between the steps of measuring and the differing resistance values. In addition, a relative speed of the vehicle and of another vehicle involved in the collision may be ascertained with the aid of the speed of the shortening.

According to one specific embodiment of the present approach, the additional resistance may also be measured in the step of measuring. Furthermore, an asymmetrical shortening of the deformation element may be ascertained in the step of ascertaining, using the resistance and the additional resistance. The deformation element may be asymmetrically damaged during an oblique impact, so that the resistance and the additional resistance may differ from one another. Conclusions concerning an angle of the impact may be drawn using this difference.

Moreover, the present approach provides a device which is designed for carrying out or implementing the steps of one variant of a method provided here, in appropriate units. The object underlying the present approach may also be quickly and efficiently achieved by this embodiment variant of the present invention in the form of a device.

In the present context, a device may be understood to mean an electrical device which processes sensor signals and outputs control and/or data signals as a function thereof. The device may include an interface which may have a hardware and/or software design. In a hardware design, the interfaces may be part of a so-called system ASIC, for example, which contains various functions of the device. However, it is also possible for the interfaces to be dedicated, integrated circuits, or to be at least partially made up of discrete components. In a software design, the interfaces may be software modules which are present on a microcontroller, for example, in addition to other software modules.

Lastly, the present approach provides a vehicle which includes the following features:

a first longitudinal chassis beam, a second longitudinal chassis beam, and a crossmember;
a first deformation device according to one specific embodiment of the present approach, the first deformation device being situated between one end of the first longitudinal chassis beam and the crossmember;
a second deformation device according to one specific embodiment of the present approach, the second deformation device being situated between one end of the second longitudinal chassis beam and the crossmember; and
a device for implementing the steps of a method for detecting a shortening of the deformation device, a measuring unit of the device being coupled to the first deformation device and to the second deformation device via interfaces of the first deformation device and of the second deformation device, respectively.

The two longitudinal chassis beams may be, for example, longitudinal metal elements which are situated in the longitudinal direction of the vehicle, for example in a front area of the vehicle, approximately in parallel to one another. The longitudinal chassis beams may also be designed for damping an impact of the vehicle. The longitudinal chassis beams may have identical lengths. A crossmember may be understood, for example, to mean a further metal element which is situated approximately perpendicularly with respect to the longitudinal chassis beams and rigidly connected to the longitudinal chassis beams via the deformation devices in order to stabilize the longitudinal chassis beams. The two deformation devices may be installed in the vehicle with little technical effort and at low cost. With the aid of the deformation devices, a passenger protection device, for example, which is present in the vehicle and coupled to the device may be triggered very quickly and reliably in the event of an impact.

Also advantageous is a computer program product having program code which may be stored on a machine-readable carrier such as a semiconductor memory, a hard disk, or an optical memory, and used for carrying out the method according to one of the specific embodiments described above, when the program product is executed on a computer or a device.

The present invention is explained in greater detail below by way of example, with reference to the appended drawings.

### BRIEF DESCRIPTION OF THE DRAWINGS

FIG. 1 shows a schematic illustration of a deformation device according to one exemplary embodiment of the present invention.

FIG. 2 shows a schematic illustration of destruction of a deformation element according to one exemplary embodiment of the present invention.

FIG. 3 shows an electrical equivalent model of a deformation device which includes four electrodes according to one exemplary embodiment of the present invention.

FIG. 4 shows an electrical equivalent model of a deformation device which includes three electrodes according to one exemplary embodiment of the present invention.

FIGS. 5a through 5d show various options for arranging two electrodes of a deformation device according to one exemplary embodiment of the present invention.

FIGS. 6a and 6b show various options for arranging three electrodes of a deformation device according to one exemplary embodiment of the present invention.

FIGS. 7a through 7c show various options for arranging four electrodes of a deformation device according to one exemplary embodiment of the present invention.

FIG. 8 shows a flow chart of a method for detecting a shortening of a deformation device according to one exemplary embodiment of the present invention.

FIG. 9 shows a block diagram of a device for carrying out a method according to one exemplary embodiment of the present invention.

FIG. 10 shows a schematic illustration of a vehicle according to one exemplary embodiment of the present invention.

### DETAILED DESCRIPTION OF THE INVENTION

In the following description of advantageous exemplary embodiments of the present invention, identical or similar reference numerals are used for the elements having a similar action which are illustrated in the various figures, and a repeated description of these elements is dispensed with.

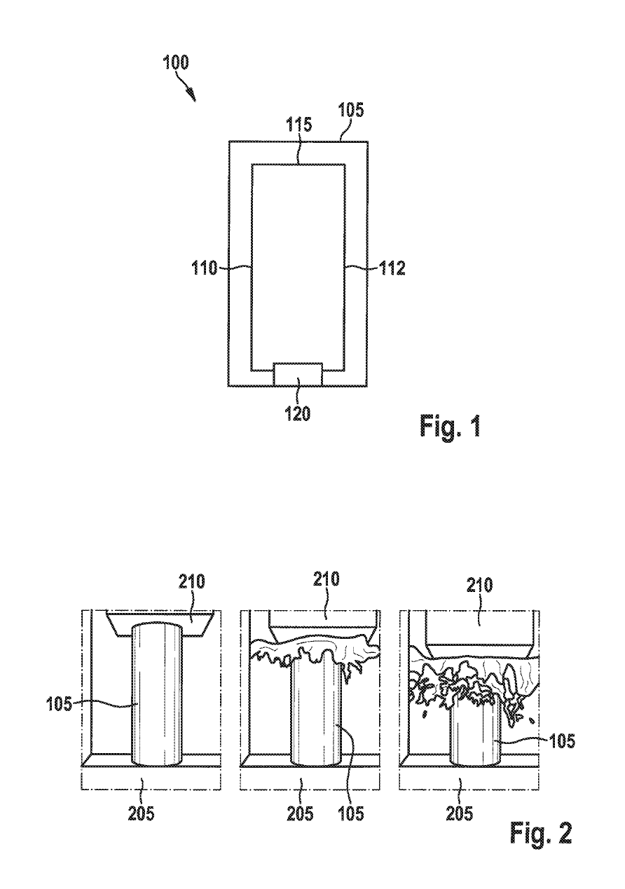

FIG. 1 shows a block diagram of a deformation device 100 according to one exemplary embodiment of the present invention. Deformation device 100 includes a deformation element 105, two electrodes 110, 112, at least one schematically indicated electrically conductive transverse line 115, which may also be formed by electrically conductive material of deformation element 105 itself, and an interface 120. If electrical transverse line 115 is formed by deformation element 105 itself, schematically indicated transverse line 115 may extend over the entire length over which electrodes 110, 112 are connected to the deformation element in an electrically conductive manner.

Deformation element 105 may be designed in the form of a straight hollow cube or hollow cylinder. For example, deformation element 105 may have a length of 20 cm and a circumference of 30 cm. Deformation element 105 may in particular be made of a weight-saving fiber composite material such as carbon fiber-reinforced plastic, for example.

Electrodes 110 are situated on deformation element 105. According to this present exemplary embodiment, electrodes 110, 112 are each designed as electrically conductive longitudinal lines, and are situated in the longitudinal direction of deformation element 105.

According to one exemplary embodiment in which the at least one transverse line 115 is designed as a separate line, the at least one transverse line 115 is situated transversely with respect to the longitudinal direction of deformation element 105 and situated on deformation element 105, between electrodes 110, 112. In the present case, the at least one transverse line 115 is situated adjacent to an upper edge area of deformation element 105 by way of example. Further transverse lines 115 may be situated between electrodes 110, 112, in parallel to the one transverse line 115 shown. One end each of the at least one transverse line 115 is contacted by one of the two electrodes 110, 112. Interface 120 may be formed at a lower edge area of deformation element 105 situated opposite from the upper edge area. Interface 120 is electrically connected to electrodes 110, 112, and is designed as an electrical contact, for example.

Electrodes 110, 112 are designed for allowing an electric current to flow through the at least one schematically indicated transverse line 115, which, depending on the specific embodiment, is formed as a separate line, as separate lines, or by deformation element 105 itself. Interface 120 is designed for connecting electrodes 110, 112 to a resistance measuring device (not illustrated). The resistance measuring device may be designed for ascertaining a resistance between electrodes 110, 112. For this purpose, the resistance measuring device may be designed for applying a voltage to electrodes 110, 112 via interface 120, and for measuring a current intensity of the current flowing between electrodes 110, 112. For example, the resistance may correspond to a value of approximately 1 kΩ at a voltage of 5 V and a current intensity of 5 mA. The resistance value between electrodes 110, 112 may be known in advance, and may thus indicate the integrity of the electrically conductive material situated between electrodes 110, 112. If the measured resistance value differs from the value known in advance, this indicates destruction or damage of the electrically conductive material situated between electrodes 110, 112. In turn, this may be used to deduce a state of the deformation element.

Deformation device 100 may be situated in a vehicle (shown in FIG. 10). Deformation element 105 may be designed for being shortened in the longitudinal direction due to the energy of an impact of the vehicle. For example, deformation element 105 may be cracked or torn by the energy of the impact, and in the process may be shortened in the longitudinal direction.

Depending on the specific embodiment, if deformation element 105, the one transverse line 115, or at least one of a plurality of transverse lines 115 connected in parallel is destroyed, the resistance between electrodes 110, 112 may increase. For example, a penetration depth of a collision partner of the vehicle may be ascertained, using the resistance.

According to one exemplary embodiment of the present invention, electrodes 110, 112 and/or the at least one transverse line 115 may be woven into a structure of deformation element 105. This may be, for example, a fiber mesh containing interlaced electrically conductive metal fibers. Electrodes 110, 112 and/or at least one transverse line 115 may optionally also be mounted on a surface of deformation element 105. For example, electrodes 110, 112 and/or transverse line 115 in the form of strip conductors may be mounted on the surface of deformation element 105.

FIG. 2 shows a schematic illustration of destruction of a deformation element 105 according to one exemplary embodiment of the present invention. Deformation element 105 is designed as a straight hollow cylinder made of a fiber-reinforced material. Deformation element 105 rests vertically on a solid base 205. A cuboidal mass body 210 for destroying deformation element 105 is mounted above an upper edge area of deformation element 105. Deformation element 105 and mass body 210 are situated at a small distance from one another. Mass body 210 is designed for being accelerated in the direction of deformation element 105, along a longitudinal axis of deformation element 105. For example, mass body 210 may be suspended in a drop tower and allowed to fall onto deformation element 105. While being allowed to fall, a mass of mass body 210 may be accelerated in such a way that deformation element 105 is destroyed when mass body 210 strikes deformation element 105.

A first illustration shows deformation element 105 in an undamaged state. Mass body 210 is initially in a neutral position. Mass body 210 is now allowed to fall. A second illustration shows accelerated mass body 210 striking deformation element 105. In the process, the upper edge area of deformation element 105 is partly cracked and partly pulverized. In a third illustration, mass body 210 has destroyed deformation element 105 by approximately one-half.

If a plurality of transverse lines connected in parallel is situated over the length of deformation element 105, or if deformation element 105 itself is electrically conductive, the transverse lines are destroyed in succession along with the destruction of the deformation element, or deformation element 105 itself is progressively destroyed, thus increasing the overall resistance. A time curve of the destruction of the deformation element may be deduced from a change in the overall resistance over time.

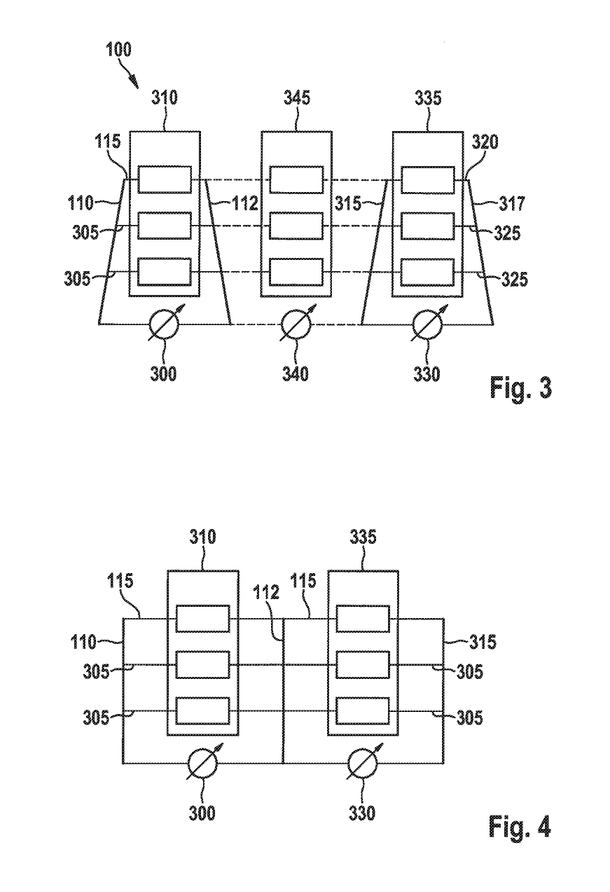

FIG. 3 shows an electrical equivalent model of a deformation device 100 according to one exemplary embodiment of the present invention. In contrast to FIG. 1, deformation device 100 shown in FIG. 3 includes a resistance measuring unit 300 for measuring the resistance between first electrode 110 and second electrode 112. In addition, deformation device 100 includes multiple, for example two in the present case, further electrically conductive transverse lines 305. Further transverse lines 305 are situated transversely with respect to the longitudinal direction of the deformation element (not illustrated) and situated on the deformation element between electrodes 110, 112, vertically offset with respect to transverse line 115, so that the position of each of transverse lines 115, 305 represents a different length of deformation element 105.

Transverse lines 115, 305 are connected to one another in parallel via electrodes 110, 112. In addition, resistance measuring unit 300 is connected in parallel to transverse lines 115, 305 via the interface. Resistance measuring unit 300 is designed for measuring a resistance 310 between electrodes 110, 112 which is a function of a characteristic of transverse lines 115, 305. Resistance 310 results from the overall resistance from the parallel connection of transverse lines 115, 305. If the deformation element is shortened in the longitudinal direction, then due to the parallel connection, resistance 310 may increase by the extent to which transverse lines 115, 305 are destroyed. For example, resistance 310 in an undamaged state of the deformation element may correspond to a value of 5 kΩ. If, for example, transverse line 115 and one of the two further transverse lines 305 are destroyed, resistance 310 may now correspond to a value of 15 kΩ.

According to one exemplary embodiment of the present invention, deformation device 100 may include two additional electrodes 315, 317. The two additional electrodes 315, 317, the same as the two electrodes 110, 112, may be situated on the deformation element. Between the two additional electrodes 315, 317, an additional electrically conductive transverse line 320 may be situated on the deformation element, transversely with respect to the longitudinal direction of the deformation element. Multiple, for example two in the present case, additional transverse lines 325 may optionally be situated between additional electrodes 315, 317, in each case at the same height as the two further transverse lines 305. Additional transverse lines 320, 325 may be connected to one another in parallel.

Furthermore, deformation device 100 may include an additional resistance measuring unit 330 for measuring an additional resistance 335 between additional electrodes 315, 317. Additional resistance measuring unit 330 may be connected to additional electrodes 315, 317 via an additional interface, and may be connected in parallel to additional transverse lines 320, 325.

The more transverse lines 305 and additional transverse lines 325 that are present, the more accurately a change in length of the deformation element may be detected. The more electrodes 310, 312, 315, 317 that are used in parallel with one another, the more accurately an asymmetrical change in length of the deformation element may be detected.

It is also conceivable, as indicated in FIG. 3, for second electrode 112 to be electrically connected to additional electrode 315. For example, for this purpose transverse line 115 and additional transverse line 320 may be part of a continuous transverse line which is contacted by electrodes 110, 112, 315, 317. Alternatively or additionally, further transverse lines 305 and further additional transverse lines 325 may each be a part of further continuous transverse lines. A particular length of the continuous transverse line and of the further continuous transverse lines may correspond, for example, to a circumference of the deformation element. The continuous transverse line and the further continuous transverse lines are indicated by dashed lines in FIG. 3. In addition, second electrode 112 and additional electrode 315 may be connected via an optional interface to an optional resistance measuring unit 340 for measuring an optional resistance 345 between electrodes 110, 112.

Even though transverse lines 115, 305, 320, 325 are described here and below as additional lines, they may also be regarded as a schematically indicated conductivity of the deformation element of deformation device 100.

Thus, it is not necessary to design electrical transverse lines 115, 305, 320, 325 as lines. This means that the deformation element, for example in the form of a CFRP crash element, is self-conducting according to exemplary embodiments, and is used in the intact state as a transverse line. With increasing destruction, the effect of the deformation element on the electrical transverse line becomes increasingly weaker. This may be measured and interpreted according to the above statements.

FIG. 4 shows an electrical equivalent model of a deformation device 100 according to one exemplary embodiment of the present invention. In contrast to FIG. 3, deformation device 100 illustrated in FIG. 4 includes a first electrode 110, a second electrode 112, and a third electrode 315. Transverse lines 115, 305 extend between electrodes 110, 315. Second electrode 112 is situated approximately centrally between electrodes 110, 315, and is connected to transverse lines 115, 305 in an electrically conductive manner. Electrodes 110, 112 are connected to resistance measuring unit 300 via an interface, and electrodes 112, 315 are connected to additional resistance measuring unit 330 via an interface. Resistance measuring unit 330 is designed for measuring additional resistance 335 between second electrode 112 and third electrode 315.

Transverse lines 110, 105, in turn, may be regarded as representative of separate electrical lines, or of an electrical transverse line of the deformation element.

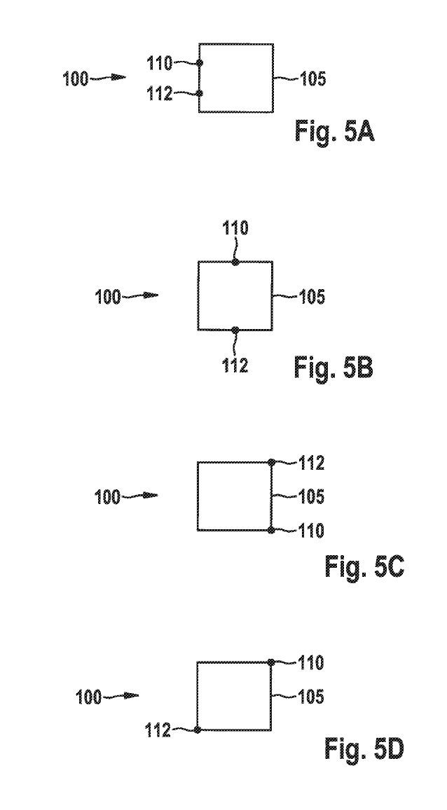

FIGS. 5a through 5d show various options for arranging two electrodes 110, 112 of a deformation device 100 according to one exemplary embodiment of the present invention. FIGS. 5a through 5d each show a schematic cross-sectional illustration of deformation device 100. Deformation device 100 includes deformation element 105 and the two electrodes 110, 112. Deformation element 105 has a rectangular cross section by way of example. Electrodes 110, 112 are illustrated as points.

In FIG. 5a, electrodes 110, 112 are situated at a small distance from one another on one side of deformation element 105.

In FIG. 5b, electrodes 110, 112 are situated on opposite sides of deformation element 105. Electrodes 110, 112 are each centrally situated on the opposite sides.

In FIG. 5c, electrodes 110, 112 are each situated on one of two adjacent corners of deformation element 105.

In FIG. 5d, electrodes 110, 112 are each situated on one of two diametrically opposed corners of deformation element 105.

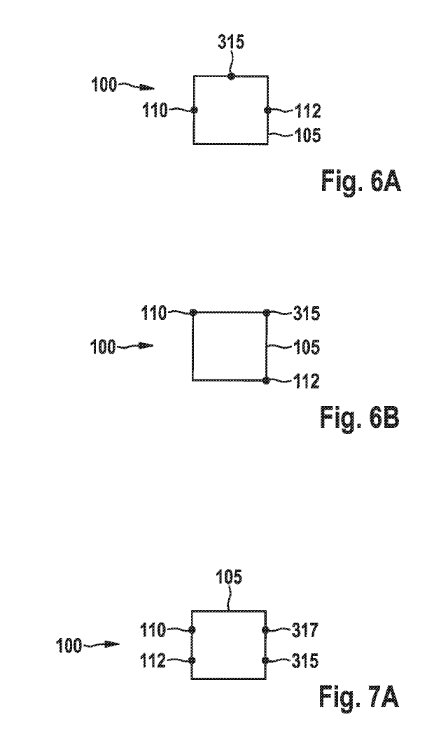

FIGS. 6a, 6b show various options for arranging three electrodes 110, 112, 315 of a deformation device 100 according to one exemplary embodiment of the present invention. In contrast to FIGS. 5a through 5d, deformation device 100 illustrated in FIGS. 6a and 6b includes third electrode 315.

In FIG. 6a, electrodes 110, 112, 315, the same as in FIG. 5b, are situated on opposite sides of deformation element 105. Third electrode 315 is centrally situated on a third side of deformation element 105.

In FIG. 6b, electrodes 110, 112, 315, the same as in FIG. 5d, are each situated on one of two diametrically opposed corners of deformation element 105. Third electrode 315 is situated on a third corner of deformation element 105.

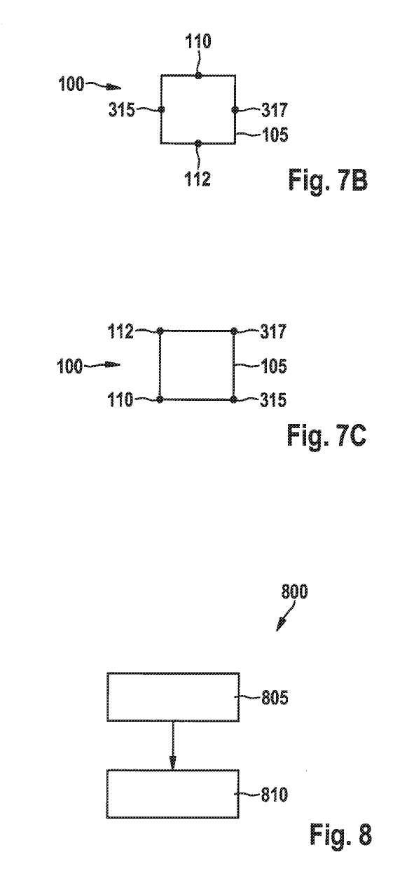

FIGS. 7a through 7c show various options for arranging four electrodes 110, 112, 315, 317 of a deformation device 100 according to one exemplary embodiment of the present invention. In contrast to FIGS. 5a through 5d, deformation device 100 illustrated in FIGS. 7a through 7c includes two additional electrodes 315, 317.

In FIG. 7a, electrodes 110, 112, 315, 317, the same as in FIG. 5a, are situated at a small distance from one another on one side of deformation element 105. Additional electrodes 315, 317 are similarly situated on one side of deformation element 105 opposite from one of electrodes 110, 112. Additional electrodes 315, 317 may optionally also be situated on one side of deformation element 105 adjacent to one of electrodes 110, 112.

In FIG. 7b, electrodes 110, 112, the same as in FIG. 5b, are each centrally situated on opposite sides of deformation element 105. Additional electrodes 315, 317 are similarly situated on two other opposite sides of deformation element 105.

In FIG. 7c, electrodes 110, 112, 315, 317, the same as in FIG. 5c, are each situated on one of two adjacent corners of deformation element 105. Additional electrodes 315, 317 are each situated on one of two other adjacent corners of deformation element 105.

In FIGS. 5a through 7c, electrodes 110, 112, 315, 317 are connected to one another via transverse line 115 and/or additional transverse line 320. Transverse line 115 and additional transverse line 320 may have different lengths, depending on the arrangement of electrodes 110, 112, 315, 317. Transverse line 115 and additional transverse line 320, as already shown in FIG. 3, may optionally be part of a single continuous transverse line which is contacted by electrodes 110, 112, 315, 317. A length of the continuous transverse line may then correspond to a circumference of deformation element 105. As previously stated, the transverse lines may also be formed by material of the deformation element itself.

FIG. 8 shows a flow chart of a method 800 for detecting a shortening of a deformation device according to one exemplary embodiment of the present invention. The measuring of the resistance between the at least two electrodes takes place in a first step 805 in order to obtain a resistance value. A length of the deformation element is ascertained in a second step 810, using the resistance value, in order to detect the shortening of the deformation device.

Optionally, step 805 of measuring may be carried out repeatedly in order to obtain a plurality of resistance values. In addition, a speed of the shortening of the deformation element may be ascertained in step 810 of ascertaining, using the plurality of resistance values.

According to one exemplary embodiment of the present invention, the additional resistance may also be measured in step 805 of measuring. In addition, an asymmetrical shortening of the deformation element may be ascertained in step 810 of ascertaining, using the resistance and the additional resistance.

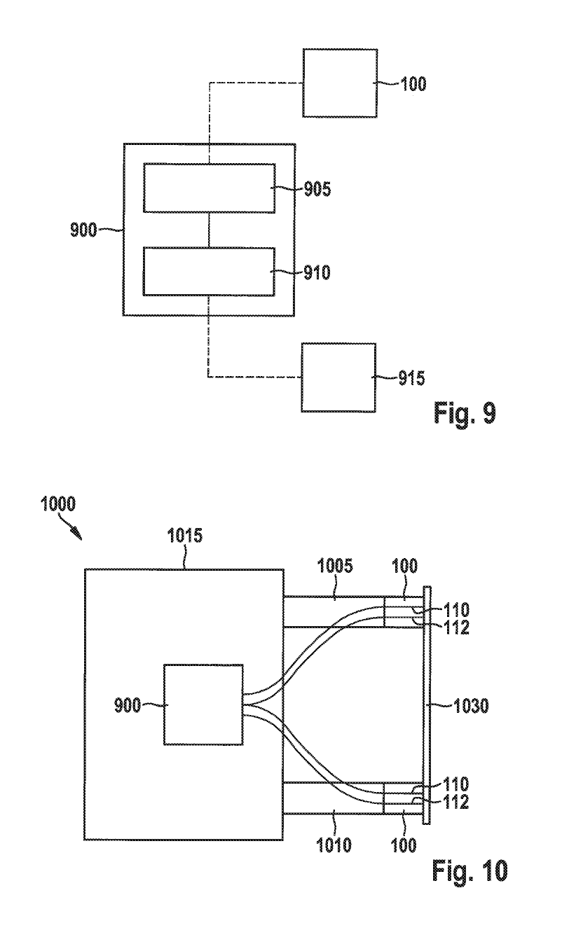

FIG. 9 shows a block diagram of a device 900 for carrying out a method 800 according to one exemplary embodiment of the present invention. Device 900 includes a measuring unit 905 and an ascertainment unit 910. Measuring unit 905 and ascertainment unit 910 are connected to one another. Measuring unit 905 is designed for measuring the resistance between the at least two electrodes. In addition, measuring unit 905 is designed for outputting the resistance value of the resistance to ascertainment unit 910. Ascertainment unit 910 is designed for ascertaining a length of the deformation element, using the resistance value. The shortening of deformation device 100 may be determined as a function of the resistance value.

Measuring unit 905 may be connected to deformation device 100 via an interface of device 900 in order to measure the resistance. Ascertainment unit 910 may also be designed for outputting a signal, which represents the length of the deformation element, to a control unit 915 via a further interface of device 900 in order to control a passenger protection device of the vehicle.

FIG. 10 shows a schematic illustration of a vehicle 1000 for use with one exemplary embodiment of the present invention. Vehicle 1000 includes a first longitudinal chassis beam 1005 and a second longitudinal chassis beam 1010. Longitudinal chassis beams 1005, 1010 are situated in parallel to one another along a longitudinal axis of vehicle 1000. For example, longitudinal chassis beams 1005, 1010 may be situated on an end-face side of a front end 1015 of vehicle 1000 in order to dampen an impact of vehicle 1000.

According to one exemplary embodiment of the present invention, first longitudinal chassis beam 1005 includes a first deformation device 100, and second longitudinal chassis beam 1010 includes a second deformation device 100. Deformation devices 100 are each mounted on one end of longitudinal chassis beam 1005, 1010. Deformation devices 100 are each rigidly connected to a crossmember 1030, it being possible for crossmember 1030 to rest on deformation devices 100. Crossmember 1030 is situated perpendicularly with respect to longitudinal chassis beams 1005, 1010. A pressure may be exerted on crossmember 1030 as the result of an impact of vehicle 1000. Deformation devices 100 may be at least partially destroyed, in particular shortened, due to the pressure.

Deformation devices 100 each include two longitudinal lines, situated in parallel to one another, as electrodes 110, 112. Device 900 is also situated in vehicle 1000. Electrodes 110, 112 may be connected to device 900, for example wirelessly or by cable, via a respective interface of deformation devices 100. Device 900 is designed for measuring a particular resistance of electrodes 110, 112 and for ascertaining a shortening of deformation devices 100, using the particular resistance value.

One exemplary embodiment of the present invention is described below with reference to FIGS. 1 through 10.

The present invention provides a crash energy management element which includes an integrated measuring device for crash sensing. The crash energy management element may also be referred to as a deformation device 100 or system. The measuring unit may also be referred to as a resistance measuring unit 300, 330, 340 or a measuring unit 905. Due to crash energy management element 100, conductive crash management system components may be enhanced with an option for crash sensing.

Crash energy management element 100, as shown in FIG. 2, for example, may be equipped with electrodes 110, 112, 315, 317 which, for example, are woven into a structure of crash energy management element 100. During a collision, a resistance of the system is ascertained and transmitted to an evaluating unit, such as device 900 shown in FIG. 9. The further the destruction of the system advances, the higher a measured resistance may be.

The resistances, which are represented by transverse lines 115, 305, 302, 325 and which may be formed by separate lines or by material of deformation element 105 itself, may be placed very close to one another, so that a quasi-continuous change in length is measurable. This may take place by weaving in conductive material and/or by imprinting conductive structures on the surface of crash energy management element 100.

A penetration depth, a penetration speed, and a piece of angular information may be directly detected in this way.

Crash energy management element 100 together with integrated measuring device 300, 330, 340, 905 may be electrically insulated and protected from environmental influences by a suitable varnish, coating, or the like. It may thus be ensured that no shunts form.

As illustrated in FIGS. 5a through 7c, electrodes 110, 112, 315, 317 may be situated in various geometries. An oblique impact or an angled collision of a vehicle may thus be sensed with only one crash element, also referred to as a deformation element 105, since the destruction of a conductivity between the possible electrode pairs may be advanced to different degrees. This asymmetry may be factored out by a comparative logic system, for example. For a plurality of electrodes 110, 112, 315, 317, redundant measurements may be carried out which may provide conclusions concerning a collision geometry, such as an oblique application of force.

A diagnosis of crash element 105 may take place via a resistance measurement. Recent airbag control units already have such a functionality for diagnosing squibs. In order to utilize this functionality for diagnosing crash element 105, electrodes 110, 112, 315, 317 should be installed in crash element 105 in such a way that a current of approximately 5 mA, corresponding to a resistance of approximately 1 kΩ, flows at a voltage of 5 V.

FIG. 10 illustrates a schematic design of a vehicle 800 which includes two longitudinal chassis beams 1005, 1010 and a connection of a deformation device 100 to an airbag control unit, also referred to as device 900. Deformation device 100 is designed as a so-called crashbox, with two electrodes 110, 112 which are woven into the fiber structure of deformation device 100. In an early crash phase, speed information, angular information, and information concerning a crash pattern may be transmitted to evaluating airbag control unit 900, also referred to as an electronic control unit (ECU). Airbag control unit 900 may thus better classify a collision, and may trigger appropriate restraint means more precisely.

Additionally or alternatively, the fiber structures of deformation device 100 may be installed in a bumper or in lateral protective parts of vehicle 800. A relative speed of the two colliding partners may thus be ascertained early.

The exemplary embodiments which are described, and shown in the figures, have been selected only as examples. Different exemplary embodiments may be combined with one another, either completely or with respect to individual features. In addition, one exemplary embodiment may be supplemented by features of another exemplary embodiment.

Furthermore, method steps according to the present invention may be repeated, and carried out in a sequence different from that described.

If an exemplary embodiment includes an “and/or” linkage between a first feature and a second feature, it may be construed in such a way that according to one specific embodiment, the exemplary embodiment includes the first feature as well as the second feature, and according to another specific embodiment includes only the first feature or only the second feature.

1-12. (canceled)

13. A deformation device for a vehicle, comprising:
a deformation element configured to be shortened in the longitudinal direction by energy of an impact of the vehicle;
at least two electrodes situated on the deformation element; and
an interface connecting the at least two electrodes to a resistance measuring unit for measuring a resistance between the at least two electrodes.

14. The deformation device as recited in claim 13, further comprising:
at least one electrically conductive transverse line which is (i) situated transversely with respect to the longitudinal direction of the deformation element and (ii) situated on the deformation element between the at least two electrodes.

15. The deformation device as recited in claim 14, wherein the at least two electrodes are configured as at least two electrically conductive longitudinal lines situated in the longitudinal direction of the deformation element.

16. The deformation device as recited in claim 14, wherein at least one of:
(i) the at least two electrodes are woven into the structure of the deformation element; and
(ii) the at least one transverse line is woven into the structure of the deformation element.

17. The deformation device as recited in claim 14, wherein at least one of:
(i) the at least two electrodes are mounted on a surface of the deformation element; and
(ii) the at least one transverse line is mounted on a surface of the deformation element.

18. The deformation device as recited in claim 14, further comprising:
a third electrode which is situated on the deformation element; and
an additional interface connecting the third electrode and one of the at least two electrodes to an additional resistance measuring unit for measuring an additional resistance between the third electrode and the one of the at least two electrodes.

19. The deformation device as recited in claim 14, further comprising:
at least two additional electrodes which are situated on the deformation element; and
an additional interface for connecting the at least two additional electrodes to an additional resistance measuring unit for measuring an additional resistance between the at least two additional electrodes.

20. A method for detecting a shortening of a deformation device including a deformation element configured to be shortened in the longitudinal direction by energy of an impact of the vehicle, at least two electrodes situated on the deformation element, and an interface connecting the at least two electrodes to a resistance measuring unit for measuring a resistance between the at least two electrodes, the method comprising:
measuring, by the resistance measuring unit, the resistance between the at least two electrodes in order to obtain a resistance value; and
ascertaining a length of the deformation element, using the resistance value, in order to detect the shortening of the deformation device.

21. The method as recited in claim 20, wherein the step of measuring is carried out repeatedly in order to obtain a plurality of resistance values, and a speed of the shortening of the deformation element is additionally ascertained as part of the ascertaining step, using the plurality of resistance values.

22. The method as recited in claim 20, wherein the deformation device additionally includes a third electrode which is situated on the deformation element, and an additional interface connecting the third electrode and one of the at least two electrodes to an additional resistance measuring unit for measuring an additional resistance between the third electrode and the one of the at least two electrodes, and wherein the additional resistance is also measured as part of the measuring step, and an asymmetrical shortening of the deformation element is ascertained as part of the ascertaining step, using the resistance between the at least two electrodes and the additional resistance between the third electrode and the one of the at least two electrodes.

23. A detection device for detecting a shortening of a deformation device including a deformation element configured to be shortened in the longitudinal direction by energy of an impact of the vehicle, at least two electrodes situated on the deformation element, and an interface connecting the at least two electrodes to a resistance measuring unit for measuring a resistance between the at least two electrodes, the detection device comprising:
a measuring unit configured to measure the resistance between the at least two electrodes in order to obtain the resistance value; and
an ascertainment unit configured to ascertain a length of the deformation element, using the resistance value, in order to detect the shortening of the deformation device.

24. A vehicle chassis system, comprising:
a first longitudinal chassis beam;
a second longitudinal chassis beam;
a crossmember;
a first deformation device including a first deformation element configured to be shortened in the longitudinal direction by energy of an impact of the vehicle, at least two electrodes situated on the first deformation element, and an interface connecting the at least two electrodes to a resistance measuring unit for measuring a resistance between the at least two electrodes, the first deformation device being situated between one end of the first longitudinal chassis beam and the crossmember;
a second deformation device including a second deformation element configured to be shortened in the longitudinal direction by energy of an impact of the vehicle, at least two electrodes situated on the second deformation element, and an interface connecting the at least two electrodes to a resistance measuring unit for measuring a resistance between the at least two electrodes, the second deformation device being situated between one end of the second longitudinal chassis beam and the crossmember; and
a detection device for detecting a shortening of the first and second deformation devices, the detection device including a measuring unit configured to measure the resistance between the at least two electrodes of the respective deformation device in order to obtain the resistance value, and an ascertainment unit configured to ascertain a length of the respective deformation element, using the resistance value, in order to detect the shortening of the respective deformation device, wherein the measuring unit of the detection device is coupled to the first and second deformation devices via respective interfaces of the first and second deformation devices.
